(19) United States
(12) Patent Application Publication
(10) Pub. No.: US 2025/0346326 A1
(43) Pub. Date: Nov. 13, 2025

(54) CHAIN TENSIONERS FOR MOORING OF OFFSHORE FLOATING STRUCTURES

(71) Applicant: I.P. HUSE AS, Harøy (NO)

(72) Inventor: Arnstein LERVIK, Harøy (NO)

(21) Appl. No.: 18/860,107

(22) PCT Filed: Mar. 30, 2023
(86) PCT No.: PCT/NO2023/050070

§ 371 Date: Oct. 25, 2024

(30) Foreign Application Priority Data
Apr. 29, 2022 (NO) 20220482

(51) Int. Cl. B63B 21/04; B63B 21/50

(52) U.S. Cl. CPC B63B 21/04; B63B 21/50; B63B 2021/505

(57) ABSTRACT

The present invention related to a seabed tensioner (30), a vessel tensioner (130) and an inline tensioner (230) for tensioning an anchor chain (20) in a mooring arrangement, said tensioners comprises a chain roller (32) with sprockets supported on a first support axle (42) within a housing (34), wherein a first part of the housing is arranged to accommodate the anchor chain (20) running around the chain roller (32), and a second part of the housing (34) has an attachment for an anchor line (16) or to a floating structure (12), said first and second parts of the housing (34) are facing in opposite directions. The present invention further discloses systems and methods for mooring a floating structure.

### FIELD OF THE INVENTION

The present invention relates to mooring of offshore floating structures such as oil and gas installations, foundations for wind turbines and fish farming cages. A seabed tensioner, vessel tensioner and inline tensioner for tensioning an anchor line in a mooring arrangement is provided. The present invention further discloses a system and a method for mooring a floating structure.

### BACKGROUND OF THE INVENTION

In-line tensioners located in the water as part of an anchor line are known. Also known are tensioners attached directly to a floating structure.

In-line tensioners used with bollard pull has the benefit of being relatively quick to connect and start tightening. The disadvantages are that is creates a break in the anchor line during tightening, which means that the tightening decreases after the tightening is completed. In-line tensioners will rotate 180 degrees after tightening and will thus create a twist in the anchor line. The chain end may be hanging under the in-line tensioner after tightening, which can lead to fatigue in chain. In-line tensioners will act as an extra lump weight in the anchor line. High fuel consumption during tightening and thus has a poor environmental profile. Cannot be tightened by vertical lifting at wide anchor spread. In-line tensioners must be handled on deck at anchor handling vessels.

In-line tensioners used with winch pull has the benefit of being able to tension with a winch without using bollard pull, and thus a good environmental profile. The disadvantages are that one must connect extra line at a bottom chain, which will involve extra marine operations. It can create up lift at anchor. May create a break in the anchor line during tightening which means that the tightening decreases after the tightening is completed. In-line tensioners will rotate 180 degrees after tightening and will thus create a twist in the anchor line. The chain end may be hanging under the in-line tensioner after tightening, which can lead to fatigue in chain. In-line tensioners will act as an extra lump weight in the anchor line. In-line tensioners must be handled on deck at anchor handling vessels.

Vessel tensioners (in-line tensioners attached to the floating structure) used with bollard has the benefits of being relatively quick to connect and start tightening, no break in the anchor line during tightening, no extra lump weight in the middle of the anchor line, and no handling of vessel tensioners on the deck at anchor handling vessel. The disadvantages are that the chain end must either be hung on the vessel tensioner or up along the leg of the floating structure which entails extra marine operations. Tightening in the active anchor line is less than in the two passive anchor lines, and the tightening therefore decreases slightly in the passive anchor lines after the tightening has ended. High fuel consumption during tightening and thus has a poor environmental profile.

Vessel tensioner used with winch pull has the benefits of little or no break in the anchor line during tightening, and no extra lump weight in the middle of the anchor line. Can be tightened up with a winch without using bollard pull, and thus has a good environmental profile. No handling of vessel tensioners on deck at the anchor handling vessel. The disadvantages are that the chain end must either be hung on the vessel tensioner or up along the leg of the floating structure, which entails additional marine operations. Tightening in the active anchor line is less than in the two passive anchor lines, and the tightening therefore decreases slightly in the passive anchor lines after the tightening is completed. One must connect an extra line at bottom chain which will involve extra marine operations.

### DISCLOSURE OF THE STATE OF ART

EP3251943A1 discloses a mooring tensioning arrangement for a floating structure or vessel, wherein the mooring tensioning arrangement comprising an anchor, a mooring line running up to the floating structure, a fairlead chain stopper arrangement arranged on the floating vessel, a midwater pulley device and a pulling unit on an anchor handling vessel. The mooring line is attached to the anchor at a first end and attached to the pulling unit on the anchor handling vessel at the second end, and the mooring line is extending from the anchor through the fairlead chain stopper arrangement on the floating structure. The fairlead chain stopper arrangement comprises a chain stopper interacting with the mooring line and a chain pulley guiding the mooring line through the fairlead chain stopper arrangement.

EP3251942A1 discloses a similar system relating to a mooring tensioning arrangement for a floating structure or vessel, comprising an anchor, a mooring line, a mooring tensioner and a working line. The mooring tensioner has a tensioning pulley. The mooring line is attached at a first end to the anchor and at a second end to the mooring tensioner, and the working line is attached at a first end to the floating structure and extending over the tensioning pulley, and the working line is attached to a pulling unit on an anchor handling vessel at a second end.

US 2020377178 A1 discloses a tensioning system of a mooring line of a floating structure. The mooring line includes separate first and second mooring line sections, with a first end of the second mooring line attached to the floating structure and a first end of the first mooring line section being attached to an anchoring device embedded in a seabed. A tensioner configured to act on the mooring line includes a body with a housing, and an inlet unit for inserting a second end of the first mooring line section into the housing of the body. The body includes an opening for the passage of a second end of the first mooring line section from the inlet unit, through the housing, and along a direction changing element. The tensioning system includes a stabilizing platform fixed to the body. At least a portion of the stabilizing platform laterally projects from the body of the tensioner.

Delmar & Vryhof, Stevadjuster (https://www.youtube.com/watch?v=nsKIV38diPY) is a solution for chain adjustment, pre-tensioning of moorings and connection or disconnection of anchor lines.

Further reference is made to WO 2020046127 A1, WO 2018025018 A1 and WO 2020165568 A1, indicating the general state in the art.

### OBJECTS OF THE PRESENT INVENTION

The present invention is in one embodiment directed to a seabed tensioner for tensioning anchor lines and mooring lines on the seabed.

The principle is that with the help of an anchor handling vessel it is possible to tighten the anchor line using for instance bollard pull, which means that there is no need to have anchor winches on board the floating structure. By for instance placing tensioning units down on the seabed near the anchor, it is possibly to tighten up both active anchor line and passive anchor lines on the opposite side of the floating structure. With three anchor lines, which seem to be a typical configuration for floating wind turbines, one gets the same tightening in the two opposite anchor lines as in the active line.

The seabed tensioning unit is a seabed tensioner that can be mounted on a runner, skid or toboggan so that it can slide along the seabed during tightening. When the anchor chain end that is connected to the anchor handling vessel is pulled, one gets a doubling of the reaction force in the active anchor line that goes up to the floating structure. This means that one does not need such a strong bollard pull on the anchor handling vessel (AHT) and is also important for achieving high tension during removal of “stretch” in the fibre ropes in the anchor lines. The angle of the tensioning wire from the anchor handling vessel can be adjusted to get a small lift on the seabed tensioner so that the pressure against the seabed is relieved during tightening.

After tightening, the excess length of the anchor chain can be laid down on the seabed. This will then be static and not exposed to dynamic loads as alternative solutions are, where the tensioning unit is located further up on the anchor line (in-line tensions) or on solutions that are attached directly to the floating structure.

Other embodiments of the invention are directed to vessel tensioner and inline tensioner.

All three chain tensioners eliminate the need for onboard floater winches since the tensioning is done by an external vessel. The tensioners are intended for permanent moored floating structures, especially, but not limited to floating wind, offshore fish farming and floating structures for the oil and gas industry.

The chain tensioners are designed with focus on having few moving components and a safe operation, with as little maintenance and failure modes as possible over the entire lifetime of the product.

The solution according to the invention will be easy to connect afterwards if it turns out that there is a need to re-tighten the anchor lines.

The anchor chain from the anchor is locked in the chain tensioners.

### SUMMARY OF THE INVENTION

The above objects are achieved with a seabed tensioner, a system for mooring a floating structure and a method for mooring a floating structure as disclosed in the independent claims.

According to a first embodiment of the invention, a seabed tensioner for tensioning an anchor chain in a mooring arrangement is provided, wherein said seabed tensioner is placeable on a seabed in proximity to an anchor, and said seabed tensioner comprises a chain roller with sprockets supported on a first support axle within a housing. A first part of the housing is arranged to accommodate the anchor chain connected to the anchor and running around the chain roller, and a second part of the housing has an attachment for an anchor line that can run to a floating structure on a surface of water, said first and second parts of the housing are facing in opposite directions. A spring-loaded locking pawl is placed within the housing and is supported on a second support axle in the first part of the housing, wherein the locking pawl is engageable with a chain link of the anchor chain prior to the anchor chain leaving the chain roller, and the locking pawl is arranged to force the chain link against one of the sprockets on the chain roller for locking the anchor chain, said sprocket being a sprocket on the chain roller facing the second part of the housing.

The housing can be connected to one or more seabed skids, allowing the seabed tensioner to slide along the seabed during tensioning of the anchor chain. The housing may be hingedly connected to the seabed skid, allowing angular adjustment of the housing.

The locking pawl can be a single spring-loaded locking pawl that automatically locks on every second chain link that passes the sprocket of the chain roller.

The housing may comprise spaced apart locking plates forming said first part of the housing and that comprises the first support axle supporting a the chain roller with sprockets and the second support axle supporting said locking pawl, and the locking plates are joined together to form said second part of the housing and that comprises the attachment for the anchor line.

Said first support axle for the chain roller can be placed vertically above the second support axle for the locking pawl.

The chain roller can comprise a central groove for accommodating a wire.

Said first and second parts of the housing are preferably facing in opposite horizontal directions, wherein an entrance in the first part of the housing for the anchor chain from the anchor and the attachment for the anchor line in the second part of the housing are linearly opposite.

Said locking pawl can be connected to an actuator, providing said spring force, and wherein the actuator is releasable to allow the locking pawl out of engagement with the sprocket on the chain roller.

The system according to the invention for mooring a floating structure comprises a seabed tensioner as disclosed for the first embodiment of the invention, and:
a floating structure on a surface of water, and at least partially submerged,
one or more passive anchor lines running in the water from the floating structure and to a seabed, said passive anchor lines being moored to the seabed,
at least one active anchor line running in the water from the floating structure to a seabed tensioner placed on the seabed in proximity to an anchor,
wherein said passive and active anchor lines are running in different directions in the water, and
an anchor chain running from the anchor and to and around a chain roller in the seabed tensioner,
wherein said anchor chain is arranged to be tensioned in an opposite direction than the direction of the active anchor line in the water.

An end part of the anchor chain, that has rounded the chain roller in the seabed tensioner, can be connectable to a tensioning wire from an anchor handling vessel.

The tensioning wire can be connected to a bollard or a winch on the anchor handling vessel and is arranged to be tensioned by the anchor handling vessel pulling in a direction away from the floating structure.

The tensioning wire can be connected to a winch on the anchor handling vessel and is arranged to be tensioned by activating the winch on the anchor handling vessel and pulling the tensioning wire in a direction away from the floating structure.

Said anchor can be a seabed drag embedment anchor.

The method according to the invention for mooring a floating structure using an anchor handling vessel and a seabed tensioner as disclosed for the first embodiment of the invention, comprises the steps:
mooring of one or more passive anchor lines to a seabed, said passive anchor lines are running between the floating structure and the seabed,
deploying a seabed tensioner on the seabed in proximity to an anchor, and connecting an active anchor line to the seabed tensioner, said active anchor line is running in the water from the floating structure to the seabed tensioner,
wherein said passive and active anchor lines are running in different directions in the water, and
connecting an anchor chain, running from the anchor and to and around a chain roller in the seabed tensioner, to a tensioning wire from the anchor handling vessel,
wherein said anchor chain is tensioned in an opposite direction than the direction of the active anchor line in the water by pulling the tensioning wire.

The method may comprise the step of sliding the seabed tensioner along the seabed during tensioning of the anchor chain.

The method may further comprise the step of connecting the tensioning wire to a bollard or a winch on the anchor handling vessel, and to tension the anchor chain by pulling in a direction away from the floating structure.

The method may further comprise the steps of connecting the tensioning wire to a winch on the anchor handling vessel, and to activate the winch to pull the tensioning wire in a direction away from the floating structure.

The anchor chain can be locked in the seabed tensioner. The method can comprise to unlock the anchor chain in the seabed tensioner using an ROV to manually manipulate a locking pawl in the seabed tensioner.

According to a second embodiment of the invention, a vessel tensioner for tensioning an anchor chain in a mooring arrangement is provided, wherein said vessel tensioner is connectable to a floating structure, and said vessel tensioner comprises a chain roller with sprockets supported on a first support axle within a housing. A first part of the housing is arranged to accommodate the anchor chain running around the chain roller, and a second part of the housing has an attachment to the floating structure, said first and second parts of the housing are facing in opposite directions. A spring-loaded locking pawl is placed within the housing and is supported on a second support axle in the first part of the housing, wherein the locking pawl is engageable with a chain link of the anchor chain prior to the anchor chain leaving the chain roller, and the locking pawl is arranged to force the chain link against one of the sprockets on the chain roller for locking the anchor chain, said sprocket being a sprocket on the chain roller facing the second part of the housing.

The locking pawl of the vessel tensioner can be a single spring-loaded locking pawl that automatically locks on every second chain link that passes the sprocket of the chain roller.

In the vessel tensioner, the first support axle for the chain roller can be placed vertically above the second support axle for the locking pawl.

Said first and second parts of the housing of the vessel tensioner are preferably facing in opposite horizontal directions, and wherein an entrance in the first part of the housing for the anchor chain and the attachment in the second part of the housing are linearly opposite.

Said locking pawl of the vessel tensioner can be connected to an actuator, providing said spring force, and wherein the actuator is releasable to allow the locking pawl out of engagement with the sprocket on the chain roller.

According to a third embodiment of the invention, an inline tensioner for tensioning an anchor chain in a mooring arrangement is provided, wherein said inline tensioner is connectable to a floating structure, and said inline tensioner comprises a chain roller with sprockets supported on a first support axle within a housing. A first part of the housing is arranged to accommodate the anchor chain running around the chain roller, and a second part of the housing has an attachment for a support chain running to the floating structure, said first and second parts of the housing are facing in opposite directions. A spring-loaded locking pawl is placed within the housing and is supported on a second support axle in the first part of the housing, wherein the locking pawl is engageable with a chain link of the anchor chain prior to the anchor chain leaving the chain roller, and the locking pawl is arranged to force the chain link against one of the sprockets on the chain roller for locking the anchor chain, said sprocket being a sprocket on the chain roller facing the second part of the housing.

The locking pawl of the inline tensioner can be a single spring-loaded locking pawl that automatically locks on every second chain link that passes the sprocket of the chain roller.

In the inline tensioner, said first support axle for the chain roller can be placed vertically above the second support axle for the locking pawl.

Said first and second parts of the housing of the inline tensioner are preferably facing in opposite horizontal directions, and wherein an entrance in the first part of the housing for the anchor chain and the attachment in the second part of the housing are linearly opposite.

Said locking pawl of the inline tensioner can be connected to an actuator, providing said spring force, and wherein the actuator is releasable to allow the locking pawl out of engagement with the sprocket on the chain roller.

The vessel tensioner and the inline tensioner can be part of similar systems and methods as disclosed above.

### DESCRIPTION OF THE FIGURES

Embodiments of the present invention will now be described, by way of example only, with reference to the following figures, wherein:

FIG. 1 shows a typical mooring arrangement according to a first embodiment of the invention.

FIG. 2 shows an enlarged view of detail A in FIG. 1.

FIG. 3 shows an enlarged view of detail B in FIG. 2.

FIG. 4 shows an enlarged view of detail C in FIG. 1.

FIGS. 5 and 6 show a seabed tensioner according to the first embodiment of the invention connected to an anchor chain and an active anchor line running to a floating structure.

FIGS. 7 and 8 show the seabed tensioner according to the invention connected to an anchor chain and a fibre rope of the active anchor line.

FIGS. 9, 10 and 11 show the seabed tensioner according to the invention in perspective view, side view and top view.

FIGS. 12 and 13 show the seabed tensioner according to the invention in cross-sectional view, in locked and unlocked position.

FIG. 14 shows an overview of typical mooring arrangement with a vessel tensioner according to a second embodiment of the invention.

FIG. 15 shows the vessel tensioner of FIG. 14 connected to a floating structure and with an anchor chain of an anchor line running through the tensioner.

FIG. 16 shows a perspective view of the vessel tensioner according to the invention.

FIGS. 17 and 18 show a cross-sectional view of the vessel tensioner according to the invention, in locked and unlocked position.

FIG. 19 shows an overview of typical mooring arrangement with an inline tensioner according to a third embodiment of the invention.

FIG. 20 shows the inline tensioner of FIG. 19 connected to a floating structure and with an anchor chain of an anchor line running through the tensioner.

FIG. 21 shows a perspective view of the inline tensioner according to the invention.

FIGS. 22 and 23 show a cross-sectional view of the inline tensioner according to the invention, in locked and unlocked position.

### DESCRIPTION OF PREFERRED EMBODIMENTS OF THE INVENTION

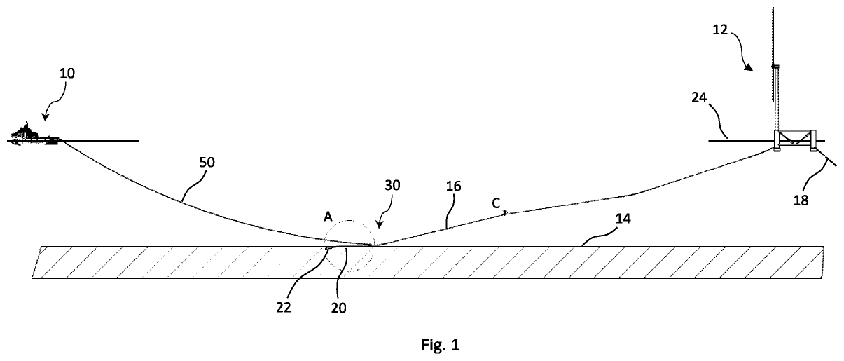

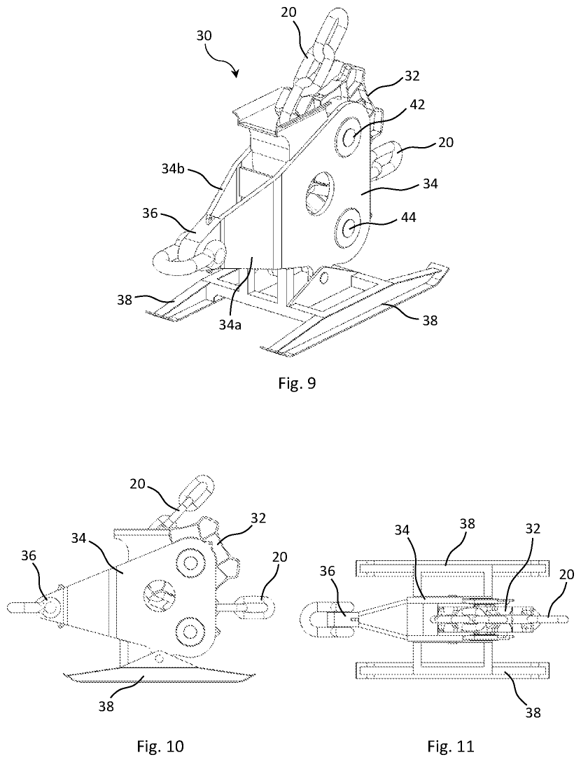

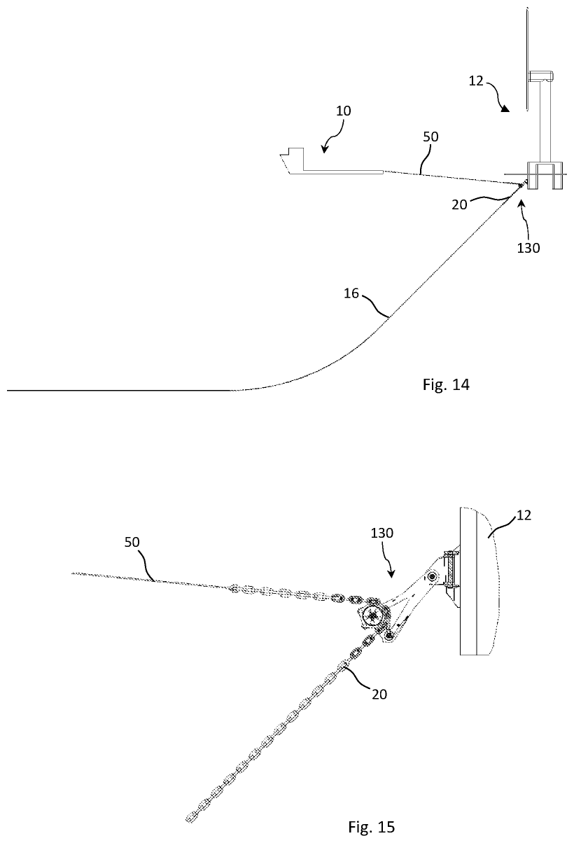

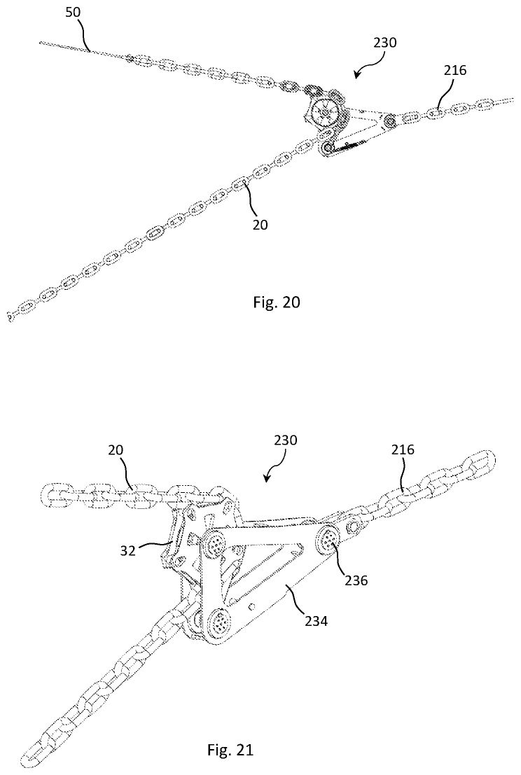

The present invention includes three basically similar chain tensioners for tensioning of mooring lines, which is based on the same technology. A first embodiment is shown in FIGS. 1-13 showing a seabed tensioner, a second embodiment is shown in FIGS. 14-18 showing a vessel tensioner, and a third embodiment is shown in FIGS. 19-23 showing an inline tensioner. The difference between the three chain tensioners is their connection to and location in the mooring line.

FIG. 1 shows an overview of a mooring system according to the invention, with a seabed tensioner 30. On the right-hand side is shown a floater in the form of a floating structure 12, for instance a floating windmill floating on a surface 24 of water and partly submerged. Passive anchor lines 18, shown partly with doted lines, are running in the water from the floating structure 12 and down to a seabed 14, where the passive anchor lines 18 are moored to the seabed 14 by using for instance anchors (not shown). The passive anchor lines 18 are connected to the floating structure and runs out in separate directions, for instance with an angle of 120° to each other.

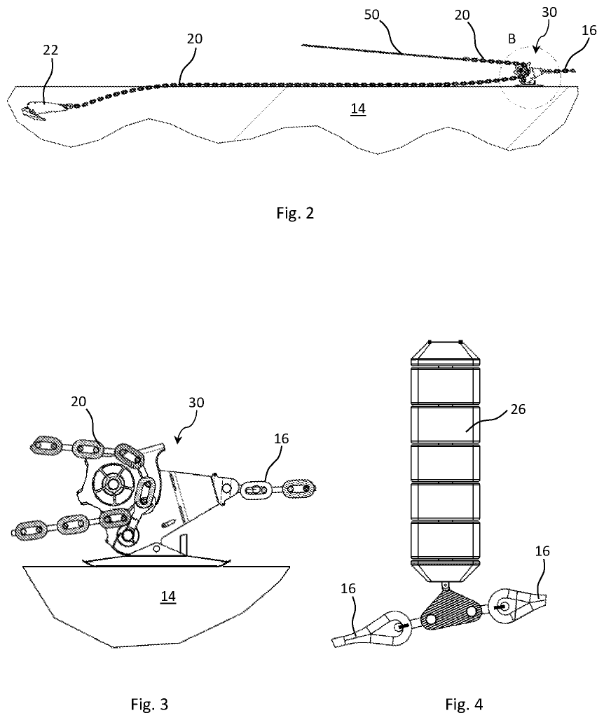

On the opposite side of the floating structure 12 is an active anchor line 16 connected and that runs in the water from the floating structure 12 and down to the seabed 14, where the active anchor line 16 is connected to a seabed tensioner 30 placed on the seabed 14 in proximity to an anchor 22, for instance of drag embedment anchor type. An anchor chain 20 is running from the anchor 22 and to and around a chain roller 32 in the seabed tensioner 30, as better seen in FIGS. 2 and 3. The anchor chain 20 is tensioned in an opposite direction than the direction of the active anchor line 16 in the water by pulling on the end of the anchor chain 20 going around the chain roller 32 in the seabed tensioner 30, which shall be explained in more detail.

With the mooring system according to invention it is possible to tighten up the entire length of all three anchor lines 16, 18 simultaneously. The anchor lines can also easily be retightened after the floating structure has been anchored for a long time.

A typical anchor line 16 as seen in FIG. 1 may comprise, starting from the floating structure 12, a top chain that in the water is connected to an upper fiber rope and a clump chain. The clump chain is further connected to a middle fiber rope connected to a subsea buoy 26, as seen in FIG. 4, showing detail C in FIG. 1. From the subsea buoy 26 runs a lower fiber rope to a bottom chain, which is connected to the seabed tensioner 30. A fiber rope 16′, for instance the lower fiber rope, may be connected directly to the seabed tensioner 30, as shown in FIGS. 7 and 8. The term “anchor line” is hereinafter used to collective disclose all or part of the anchor line as explained.

On the left-hand side of FIG. 1 is shown an anchor handling vessel (AHT) on the surface 24. A tensioning wire 50 is running in the water and down to the seabed tensioner 30, where an end part of the anchor chain 20, that has rounded the chain roller 32 in the seabed tensioner 30, is connected to the tensioning wire 50 from the anchor handling vessel 10.

The anchor chain 20 is tensioned in an opposite direction than the direction of the active anchor line 16 in the water by pulling on the end of the anchor chain 20 going around the chain roller 32 in the seabed tensioner 30

The tensioning wire 50 is preferably connected to a bollard or a winch on the anchor handling vessel 10 and is tensioned by the anchor handling vessel 10 pulling in a direction away from the floating structure 12. The anchor handling vessel can thus quickly connect and start tightening. It further provides a doubling of power in the anchor line in relation to the traction of the anchor handling vessel 10.

However, the tightening can be done with a winch instead of bollard pull, using for instance reaction anchors attached to anchor handling vessel. The tensioning wire 50 is then connected to the winch on the anchor handling vessel 10 and is tensioned by activating the winch on the anchor handling vessel 10 and pulling in the tensioning wire 50 in a direction away from the floating structure 12.

With the present mooring system, it is possible to avoid a break in the active anchor line 16 during tightening. Further, the tightening force does not change after the anchor handling vessel relieves the force.

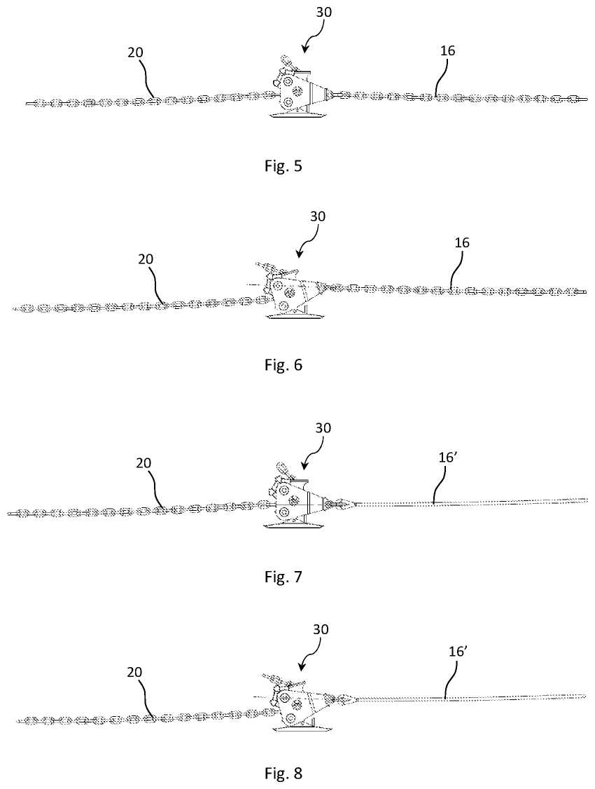

FIGS. 5 and 7 show a situation when there is no tension from the anchor handling vessel 10. The active anchor line 16 and the anchor chain 20 from the anchor 22 are in line with each other. When there is tension from the anchor handling vessel by pulling on the tensioning wire 50, the seabed tensioner 30 will slightly change angle, as seen in FIGS. 6 and 8, as there will be a force pulling on the end of the anchor chain 20.

The invention makes it possible to connect fiber rope 16′ directly to the seabed tensioner 30 because the attachment point 36 is placed so high that the fiber rope does not contact the seabed 14.

FIGS. 9 to 13 shows the seabed tensioner 30 according to the first embodiment of the invention in detail.

The seabed tensioner 30 comprises a chain roller 32 placed within a housing 34.

The housing 32 can further be connected to one or more seabed skids 38, allowing the seabed tensioner 30 to slide along the seabed 14 during tensioning of the anchor chain 20. By having the housing 32 hingedly connected to the seabed skid 38, angular adjustment of the housing 34 is permitted. 10. Having hinged skids 38 that can slide along the seabed 14, allows tension to be adjusted according to reaction forces from the anchor lines.

The housing 34 further comprises spaced apart locking plates 34a,34b forming a first part of the housing and that comprises a first support axle 42 supporting a chain roller 32 with sprockets 32a-32n and a second support axle 44 supporting a locking pawl 40. The first support axle 42 and the second support axle 44 can be placed in-line, one above the other, i.e. on the same vertical axis. The locking plates 34a,34b are joined together to form a second part of the housing 34 that comprises an attachment 36 for the active anchor line 16.

The first part of the housing 34 receives and accommodates the anchor chain 20 running from the anchor 22 and around the chain roller 32, and the second part of the housing 34 can be connected to the active anchor line 16 running to the floating structure 12 on the surface 24 of water. The first part and the second part of the housing 34 are as shown facing in opposite directions, i.e. in opposite horizontal direction compared to the seabed 14 as apparent from for instance FIG. 2. Thus, an entrance in the first part of the housing 34 for the anchor chain 20 from the anchor 22 and the attachment 36 for the anchor line 16 in the second part of the housing 34 are linearly opposite, as shown for instance in FIGS. 5 and 7, when the anchor chain 20 in the seabed tensioner 30 is not tensioned by the anchor handling vessel 10, i.e. in the installed and moored position.

The at least one locking pawl 40 is placed adjacent and directly below said chain roller 32 for locking or releasing the anchor chain 20. The locking pawl 40 is for instance a single spring-loaded locking pawl that automatically locks on every second chain link that passes the sprockets of the chain roller 32. An actuator 46, for instance a cylinder with a spring, can be placed adjacent the locking pawl 40 in the housing 34, and be connected to an actuator arm 40a on a first part of the locking pawl 40. The spring force in the actuator will act on the actuator arm 40a and force the locking pawl 40 to pivot around the support axle 44 and into engagement with a sprocket 32a on the chain roller 32. The spring force may be provided by other means, such as hydraulic or pneumatic force, but using a spring is a simple and easy option.

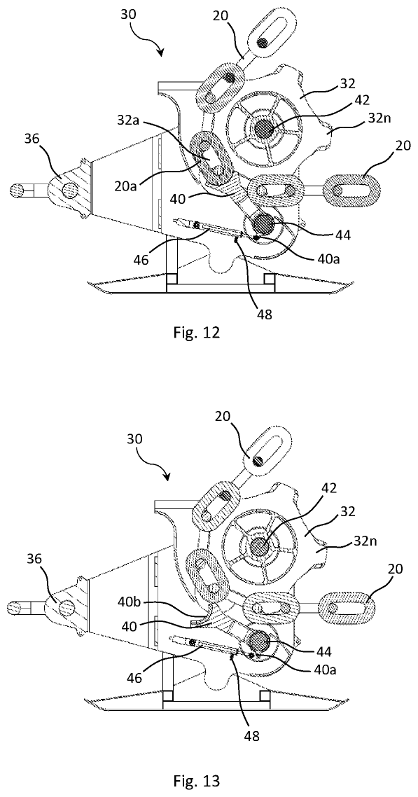

A second part of the locking pawl 40 has a concave abutment surface 40b for engagement and abutment with a chain link 20a of the chain 20, and which forces the chain link 20a against the sprocket 32a of the chain roller 32. The horizontal chain link will be resting towards the chain roller 32 and in-between two sprockets. The vertical chain link will be held by the locking pawl 40, as seen in FIG. 12.

The sprocket 32a the chain link 20a is locked against, is a sprocket on the chain roller 32 facing the second part of the housing 34.

As seen in FIG. 12, the locking pawl 40 is locked against the chain link 20a that is to the left (in the drawing) of the support axle 42 supporting the chain roller 32, such that locking happens after about a quarter turn of the chain roller 32. The first free chain link (to the right of the locking pawl) is a vertical chain link that can take angular movement of the chain 20.

Hence, during the tensioning of the mooring line, the locking pawl 40 will have a ratchet function, making the locking mechanism fail-safe. The ratchet function is achieved by spring loading the locking pawl 40, so that the locking pawl 40 is pushing against the chain 20 and automatically supports the closest chain link 20a in case of failure or when the required tension is achieved.

The design of all the chain tensioners 30, 130,230 allows for the chain exit point to be tangential to the chain roller 32 during both tensioning and after the external force from the vessel is disconnected. This eliminates the need for a bending shoe at the exit point of the chain tensioner, and any damage to the chain during the tensioning operation. The elimination of the need of a bending shoe also provides a better control of the forces during tensioning. This is because there will not be generated any extra frictional forces or other aspects from the chain going over a bending shoe.

Such a solution will consist of few moving parts and will not need synchronization, as double pawls do. If one need to open the locking pawl 40 by e.g. replacement of the anchor chain, this can be done with the assistance of an ROV, which manually or by i.e. a hydraulic power source can take the locking pawl 40 out of engagement with the anchor chain 20.

When there is a need to open the locking pawl 40, there will be an interface 48 that is capable for a ROV to connect to and power the actuator 46. The actuator 46 normally drags the locking pawl to locked position with the spring force, but when pressure is applied the locking pawl 40 can be opened. To open the locking pawl 40, the line tension needs to be relieved, ensuring that the pressure on the locking pawl 40 from the chain 20 is relieved.

The arrangement of the chain roller 32 with sprockets, locking pawl 40, support axles 42,44 and actuator 46 is similar for the seabed tensioner 30, the vessel tensioner 130 and the inline tensioner 230.

The seabed tensioner 30 according to the invention may in an alternative embodiment have a chain roller 32 that comprises a central groove for accommodating an additional wire.

With the chain tensioner according to the invention, it is provided a tensioner in where the locking pawl 40 is self-locking during tightening. The locking pawl is simple and does not need synchronization as double pawls do.

The anchor can be a seabed drag embedment anchor, or any suitable type of anchor.

A second embodiment is shown in FIGS. 14-18 and is showing a vessel tensioner 130. The vessel tensioner 130 is pivotably connected to a hull of the floating structure 12. An anchor line 16 is running from the anchor on the seabed, wherein an anchor chain 20, being a part of the anchor line 16, is running through the vessel tensioner 130 and is connected to the vessel 10 by a tensioning wire 50. Similarly, passive anchor lines (same as previously shown anchor lines 18) are running in the water from the floating structure 12 and down to the seabed 14, where the passive anchor lines are moored to the seabed 14 by using for instance anchors (not shown). The passive anchor lines are connected to the floating structure and runs out in separate directions, for instance with an angle of 120° to each other.

The anchor chain 20 is tensioned as previously mentioned in an opposite direction than the direction of the active anchor line 16 in the water by pulling on the end of the anchor chain 20 going around the chain roller 32 in the vessel tensioner 130

The tensioning wire 50 is preferably connected to a bollard or a winch on the anchor handling vessel 10 and is tensioned by the anchor handling vessel 10 pulling in a direction away from the floating structure 12.

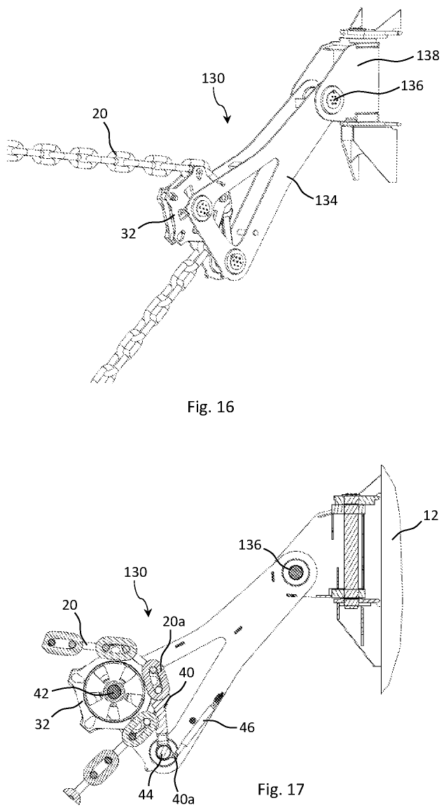

The arrangement of the chain roller 32 with sprockets, locking pawl 40, support axles 42,44 and actuator 46 is similar as disclosed above. The housing 134 is somewhat different, i.e. more elongated, and is hingedly and pivotably connected to the hull of the floating structure 12, as for instance seen in FIG. 16 showing a hinge connection 138.

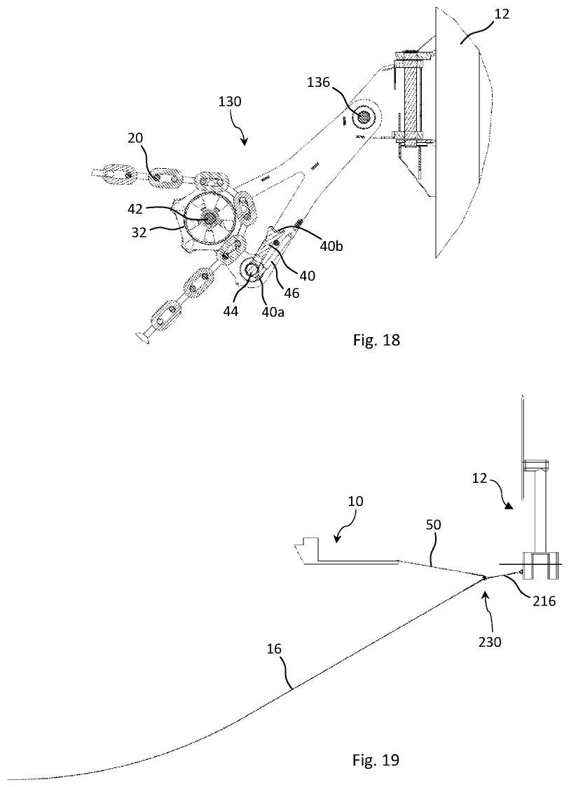

As seen in FIG. 17 the locking pawl 40 will engage with the chain link 20a in the anchor chain 20 in a similar manner as disclosed above when the chain 20 is pulled through the vessel tensioner 130. FIG. 18 shows the locking pawl 40 out of engagement with the chain 20.

A third embodiment is shown in FIGS. 19-23 and is showing an inline tensioner 230. The inline tensioner 230 is connected by a support chain 216 to the floating structure 12. An anchor line 16 is running from the anchor on the seabed, wherein an anchor chain 20, being a part of the anchor line 16, is running through the inline tensioner 230 and is connected to the vessel 10 by a tensioning wire 50. Similarly, passive anchor lines (same as previously shown anchor lines 18) are running in the water from the floating structure 12 and down to the seabed 14, where the passive anchor lines are moored to the seabed 14 by using for instance anchors (not shown). The passive anchor lines are connected to the floating structure and runs out in separate directions, for instance with an angle of 120° to each other.

The anchor chain 20 is tensioned as previously mentioned in an opposite direction than the direction of the active anchor line 16 in the water by pulling on the end of the anchor chain 20 going around the chain roller 32 in the inline tensioner 230

The tensioning wire 50 is preferably connected to a bollard or a winch on the anchor handling vessel 10 and is tensioned by the anchor handling vessel 10 pulling in a direction away from the floating structure 12.

The arrangement of the chain roller 32 with sprockets, locking pawl 40, support axles 42,44 and actuator 46 is as disclosed above. The housing 234 is somewhat different, i.e. more elongated

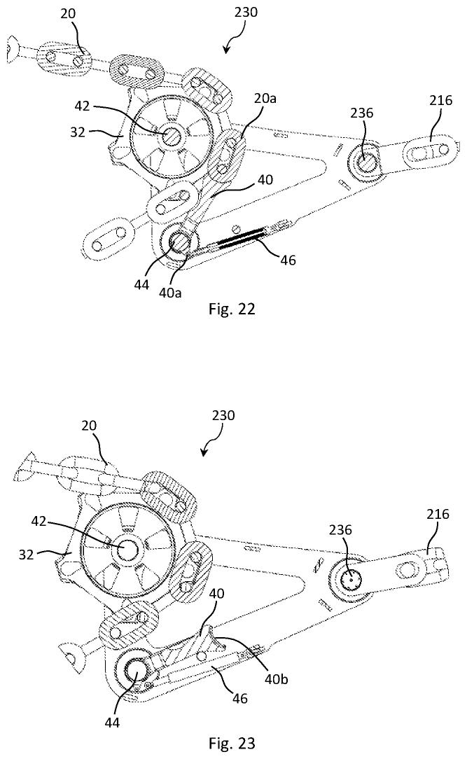

As seen in FIG. 22 the locking pawl 40 will engage with the chain link 20a in the anchor chain 20 i similar manner as disclosed when the chain 20 is pulled through the inline tensioner 230. FIG. 23 shows the locking pawl 40 out of engagement with the chain 20.

When the tensioning is completed, the part of the mooring line towards the vessel, will become passive until the next time it is necessary to tension or disconnect the line. With respect to the vessel tensioner, the line will be cut of, and the rest will be resting in the wheel. With respect to the inline tensioner, it will depend on the mooring design if it is necessary to cut the chain. After tensioning the inline tensioner will flip over due to the position of the center of gravity, so that the excess chain will hang vertically underneath the tensioner.

1. A seabed tensioner (30) for tensioning an anchor chain (20) in a mooring arrangement, wherein said seabed tensioner (30) is placeable on a seabed (14) in proximity to an anchor (22), and said seabed tensioner (30) comprises a chain roller (32) with sprockets supported on a first support axle (42) within a housing (34), wherein
a first part of the housing is arranged to accommodate the anchor chain (20) connected to the anchor (22) and running around the chain roller (32), and a second part of the housing (34) has an attachment (36) for an anchor line (16) that can run to a floating structure (12) on a surface (24) of water, said first and second parts of the housing (34) are facing in opposite directions, characterized in that
a spring-loaded locking pawl (40) is placed within the housing (34) and supported on a second support axle (44) in the first part of the housing (34), wherein the locking pawl (40) is engageable with a chain link (20a) of the anchor chain (20) prior to the anchor chain (20) leaving the chain roller (32), and the locking pawl (40) is arranged to force the chain link (20a) against one of the sprockets (32a) on the chain roller (32) for locking the anchor chain (20), said sprocket (32a) being a sprocket on the chain roller (32) facing the second part of the housing (34).

2. The seabed tensioner (30) according to claim 1, wherein said housing (32) is connected to one or more seabed skids (38), allowing the seabed tensioner (30) to slide along the seabed (14) during tensioning of the anchor chain (20).

3. The seabed tensioner (30) according to claim 2, wherein said housing (32) is hingedly connected to the seabed skid (38), allowing angular adjustment of the housing (34).

4. The seabed tensioner (30) according to claim 1, wherein the locking pawl (40) is a single spring-loaded locking pawl that automatically locks on every second chain link that passes the sprocket of the chain roller (32).

5. The seabed tensioner (30) according to claim 1, wherein the housing (34) comprises spaced apart locking plates (34a,34b) forming said first part of the housing and that comprises the first support axle (42) supporting the chain roller (32) with sprockets and the second support axle (44) supporting said locking pawl (40), and the locking plates (34a,34b) are joined together to form said second part of the housing (32) and that comprises the attachment (36) for the anchor line (16).

6. The seabed tensioner (30) according to claim 1, wherein said first support axle (42) for the chain roller (32) is placed vertically above the second support axle (44) for the locking pawl (40).

7. The seabed tensioner (30) according to claim 1, wherein said chain roller (32) comprises a central groove for accommodating a wire.

8. The seabed tensioner (30) according to claim 1, wherein said first and second parts of the housing (34) are facing in opposite horizontal directions, and wherein an entrance in the first part of the housing (34) for the anchor chain (20) from the anchor (22) and the attachment (36) for the anchor line (16) in the second part of the housing (34) are linearly opposite.

9. The seabed tensioner (30) according to claim 1, wherein said locking pawl (40) is connected to an actuator (46), providing said spring force, and wherein the actuator (46) is releasable to allow the locking pawl (40) out of engagement with the sprocket (32a) on the chain roller (32).

10. A system for mooring a floating structure (12), wherein said system comprises a seabed tensioner (30) according to claim 1, and
a floating structure (12) on a surface (24) of water, and at least partially submerged,
one or more passive anchor lines (18) running in the water from the floating structure and to a seabed (14), said passive anchor lines (18) being moored to the seabed (14),
at least one active anchor line (16) running in the water from the floating structure to a seabed tensioner (30) placed on the seabed (14) in proximity to an anchor (22),
wherein said passive and active anchor lines (18,16) are running in different directions in the water, and
an anchor chain (20) running from the anchor (22) and to and around a chain roller (32) in the seabed tensioner (30),
wherein said anchor chain (20) is arranged to be tensioned in an opposite direction than the direction of the active anchor line (16) in the water.

11. The system according to claim 10, wherein the seabed tensioner (30) comprises one or more seabed skids (38), allowing the seabed tensioner (30) to slide along the seabed (14) during tensioning of the anchor chain (20).

12. The system according to claim 10, wherein an end part of the anchor chain (20), that has rounded the chain roller (32) in the seabed tensioner (30), is connectable to a tensioning wire (50) from an anchor handling vessel (10).

13. The system according to claim 12, wherein the tensioning wire (50) is connected to a bollard or a winch on the anchor handling vessel (10), and is arranged to be tensioned by the anchor handling vessel (10) pulling in a direction away from the floating structure (12).

14. The system according to claim 12, wherein the tensioning wire (50) is connected to a winch on the anchor handling vessel (10), and is arranged to be tensioned by activating the winch on the anchor handling vessel (10) and pulling the tensioning wire (50) in a direction away from the floating structure (12).

15. A method for mooring a floating structure (12) using an anchor handling vessel (10) and a seabed tensioner (30) according to claim 1, wherein the method comprises the steps:
mooring of one or more passive anchor lines (18) to a seabed (14), said passive anchor lines are running between the floating structure and the seabed (14),
deploying a seabed tensioner (30) on the seabed (14) in proximity to an anchor (22), and connecting an active anchor line (16) to the seabed tensioner (30), said active anchor line (16) is running in the water from the floating structure to the seabed tensioner (30),
wherein said passive and active anchor lines (18,16) are running in different directions in the water, and
connecting an anchor chain (20), running from the anchor (22) and to and around a chain roller (32) in the seabed tensioner (30), to a tensioning wire (50) from the anchor handling vessel (10),
wherein said anchor chain (20) is tensioned in an opposite direction than the direction of the active anchor line (16) in the water by pulling the tensioning wire (50).

16. The method according to claim 15, wherein the method comprises the step of sliding the seabed tensioner (30) along the seabed (14) during tensioning of the anchor chain (20).

17. The method according to claim 15, wherein the method comprises the step of connecting the tensioning wire (50) to a bollard or a winch on the anchor handling vessel (10), and to tension the anchor chain (20) by pulling in a direction away from the floating structure (12).

18. The method according to claim 15, wherein the method comprises the steps of connecting the tensioning wire (50) to a winch on the anchor handling vessel (10), and to activate the winch to pull the tensioning wire (50) in a direction away from the floating structure (12).

19. The method according to claim 15, wherein the method comprises the step of locking the anchor chain (20) in the seabed tensioner (30).

20. The method according to claim 19, wherein the method comprises the step of unlocking the anchor chain (20) in the seabed tensioner (30) using an ROV to manually manipulate a locking pawl (40) in the seabed tensioner (30).

21. A vessel tensioner (130) for tensioning an anchor chain (20) in a mooring arrangement, wherein said vessel tensioner (130) is connectable to a floating structure (12), and said vessel tensioner (130) comprises a chain roller (32) with sprockets supported on a first support axle (42) within a housing (134), wherein
a first part of the housing (134) is arranged to accommodate the anchor chain (20) running around the chain roller (32), and a second part of the housing (134) has an attachment (136) to the floating structure (12), said first and second parts of the housing (134) are facing in opposite directions, characterized in that
a spring-loaded locking pawl (40) is placed within the housing (134) and supported on a second support axle (44) in the first part of the housing (134), wherein the locking pawl (40) is engageable with a chain link (20a) of the anchor chain (20) prior to the anchor chain (20) leaving the chain roller (32), and the locking pawl (40) is arranged to force the chain link (20a) against one of the sprockets (32a) on the chain roller (32) for locking the anchor chain (20), said sprocket (32a) being a sprocket on the chain roller (32) facing the second part of the housing (134).

22. The vessel tensioner (130) according to claim 21, wherein the locking pawl (40) is a single spring-loaded locking pawl that automatically locks on every second chain link that passes the sprocket of the chain roller (32).

23. The vessel tensioner (130) according to claim 21, wherein said first support axle (42) for the chain roller (32) is placed vertically above the second support axle (44) for the locking pawl (40).

24. The vessel tensioner (130) according to claim 21, wherein said first and second parts of the housing (134) are facing in opposite horizontal directions, and wherein an entrance in the first part of the housing (134) for the anchor chain (20) and the attachment (136) in the second part of the housing (134) are linearly opposite.

25. The vessel tensioner (30) according to claim 21, wherein said locking pawl (40) is connected to an actuator (46), providing said spring force, and wherein the actuator (46) is releasable to allow the locking pawl (40) out of engagement with the sprocket (32a) on the chain roller (32).

26. An inline tensioner (230) for tensioning an anchor chain (20) in a mooring arrangement, wherein said inline tensioner (230) is connectable to a floating structure (12), and said inline tensioner (230) comprises a chain roller (32) with sprockets supported on a first support axle (42) within a housing (234), wherein
a first part of the housing (234) is arranged to accommodate the anchor chain (20) running around the chain roller (32), and a second part of the housing (234) has an attachment (236) for a support chain (216) running to the floating structure (12), said first and second parts of the housing (234) are facing in opposite directions, characterized in that
a spring-loaded locking pawl (40) is placed within the housing (234) and supported on a second support axle (44) in the first part of the housing (234), wherein the locking pawl (40) is engageable with a chain link (20a) of the anchor chain (20) prior to the anchor chain (20) leaving the chain roller (32), and the locking pawl (40) is arranged to force the chain link (20a) against one of the sprockets (32a) on the chain roller (32) for locking the anchor chain (20), said sprocket (32a) being a sprocket on the chain roller (32) facing the second part of the housing (234).

27. The inline tensioner (230) according to claim 26, wherein the locking pawl (40) is a single spring-loaded locking pawl that automatically locks on every second chain link that passes the sprocket of the chain roller (32).

28. The inline tensioner (230) according to claim 26, wherein said first support axle (42) for the chain roller (32) is placed vertically above the second support axle (44) for the locking pawl (40).

29. The inline tensioner (230) according to claim 26, wherein said first and second parts of the housing (234) are facing in opposite horizontal directions, and wherein an entrance in the first part of the housing (234) for the anchor chain (20) and the attachment (236) in the second part of the housing (234) are linearly opposite.

30. The inline tensioner (230) according to claim 26, wherein said locking pawl (40) is connected to an actuator (46), providing said spring force, and wherein the actuator (46) is releasable to allow the locking pawl (40) out of engagement with the sprocket (32a) on the chain roller (32).
